(19) United States
(12) Patent Application Publication
(10) Pub. No.: US 2026/0134638 A1
(43) Pub. Date: May 14, 2026

(54) METHOD AND SYSTEM FOR DYNAMIC AUGMENTED REALITY DISPLAY

(71) Applicant: Flying Flamingos India Private Limited, Bangalore (IN)

(72) Inventors: Amit Gaiki, Bangalore (IN); Shourya Agarwal, Ajmer (IN); Malhar Patil, Nagpur (IN); Divyansh Gupta, Banswara (IN)

(73) Assignee: Flying Flamingos India Private Limited, Bangalore (IN)

(21) Appl. No.: 19/388,256

(22) Filed: Nov. 13, 2025

(30) Foreign Application Priority Data
Nov. 13, 2024 (IN) 202441087821

(51) Int. Cl. G06T 19/00; G06F 3/01; G06T 15/00; G06V 20/20; H04N 13/178

(52) U.S. Cl. CPC G06T 19/006; G06F 3/011; G06F 3/017; G06T 15/005; G06V 20/20; H04N 13/178

(57) ABSTRACT

A computer-implemented method, a computing system, and a non-transitory computer-readable storage medium are provided for dynamic rendering of mixed reality (MR) content on a communication device. The method includes detecting a triggering action for initiating access to MR content, activating a modular mixed reality engine, and recognizing a usage context associated with hardware capabilities of the communication device. Based on the recognized usage context, at least one mixed reality module is dynamically identified and loaded within a secure execution framework of the modular mixed reality engine. The mixed reality content is rendered in real time with adaptive resource allocation and sandboxed modular execution that optimizes graphical and computational resource utilization. The execution of the instructions improves operation of the communication device by reducing rendering latency, enhancing frame stability, and maintaining spatial alignment. Also, the executed instructions cause lightweight, low-resource mixed reality rendering on devices with limited processing and memory capacity.

### CROSS-REFERENCE TO RELATED APPLICATIONS

The present application claims the benefit of Indian Provisional Patent Application No. 202441087821, filed Nov. 13, 2024, all of which are hereby incorporated by reference in their entirety for all purposes.

### TECHNICAL FIELD

The present disclosure relates to the field of mixed reality systems and methods. Specifically, the present disclosure relates to systems and methods for rendering mixed reality content at a communication device.

### BACKGROUND

Mixed Reality (MR) technologies combine elements of Augmented Reality (AR) and Virtual Reality (VR) to blend digital content with the user's real-world environment. Modern communication devices such as smartphones, tablets, and wearable displays allow users to interact with virtual objects, access contextual information, and experience immersive environments through real-time rendering and sensor-based tracking.

Current Mixed Reality applications are often platform-dependent and require full installation before use, creating inconsistencies across devices and limiting accessibility. While lightweight instant applications have emerged to simplify access, they often face performance constraints related to processing power, memory, and network resources. The limitations restrict real-time spatial processing and adaptive rendering. This is more prominent on devices with limited hardware capabilities, highlighting the need for a more efficient and modular framework for dynamic mixed reality content rendering.

### SUMMARY

In a second aspect, the present invention provides a computing system for rendering mixed reality (MR) content at a communication device. The computing system includes one or more processors and a non-transitory memory. The non-transitory memory stores instructions that cause the one or more processors to detect a triggering action of a plurality of triggering actions for accessing the mixed reality (MR) content at a communication device. In addition, the one or more processors are caused to activate a modular mixed reality engine based on detection of the triggering action of the plurality of triggering actions at the communication device. The modular mixed reality engine includes a plurality of mixed reality (MR) modules. Moreover, the one or more processors are caused to recognize a usage context associated with hardware capabilities of the communication device and environmental data in real time. Further, the one or more processors are caused to select at least one mixed reality (MR) module from a plurality of mixed reality (MR) modules based on one or more pre-defined criteria and the usage context. Next, the one or more processors are caused to dynamically load the at least one selected mixed reality (MR) module through an instant application executed within a transient runtime environment on the communication device. Further, the one or more processors are caused to render the mixed reality (MR) content in real time on the communication device by executing one or more functionalities of the at least one selected mixed reality module. Furthermore, the computing system causes execution of context-aware module selection, adaptive resource allocation, and sandboxed modular execution for optimized graphical and computational resource usage, reduce rendering latency, and improves frame stability. In addition, the computing system performs coordinated execution of the instructions using the one or more processors to improve system performance through adaptive resource allocation, context-aware module management, and sandboxed execution. The computing system executes the instructions to optimize resource utilization, reduce latency, enhance frame stability, and maintain spatial alignment. The dynamic loading of the at least one mixed reality module causes lightweight, real-time mixed reality content rendering on devices with limited processing and memory resources.

In some embodiments, the plurality of triggering actions is configured based on the hardware capabilities of the communication device. The plurality of triggering actions includes at least scanning a Quick Response (QR) code through a camera module of the communication device, selecting a hyperlink received on the communication device, or detecting a near-field communication (NFC) tag through the communication device

In some embodiments, the scanning of the Quick Response (QR) code includes capturing an image of the QR code using the camera module of the communication device, decoding the captured image to extract encoded information, and using the extracted information to initiate the activation of the modular mixed reality engine.

In some embodiments, clicking on the hyperlink received on the communication device facilitates initiating a process of loading metadata linked to the hyperlink for activating the modular mixed reality engine. The metadata includes at least one of a mixed reality (MR) experience identifier, asset locations, and one or more parameters controlling the mixed reality (MR) experience.

In some embodiments, the detection of the NFC tag through the communication device includes establishing a near-field communication session, retrieving data stored on the NFC tag and utilizing the retrieved data to activate the at least one selected modular mixed reality engine.

In some embodiments, each of the plurality of triggering actions includes an embedded metadata. The metadata includes device-specific parameters corresponding to the hardware capabilities of the communication device to cause adaptive loading of lightweight mixed reality modules. The metadata includes at least one of a mixed reality (MR) experience identifier, asset locations, and one or more parameters controlling the mixed reality (MR) experience.

In some embodiments, the usage context is determined by evaluating a plurality of parameters corresponding to the hardware capabilities of the communication device. The plurality of parameters includes at least one of CPU utilization, GPU utilization, memory availability, network conditions, thermal thresholds or battery condition of the communication device to dynamically control module selection and resource allocation.

In some embodiments, the plurality of mixed reality (MR) modules includes a flat image tracking module, a curved image tracking module, a ground tracking module, and an object tracking module. Each of the plurality of mixed reality modules is associated with one or more pre-defined functionalities configured for the dynamic loading, execution, and unloading of the plurality of mixed reality modules according to the hardware capabilities of the communication device.

In some embodiments, the adaptive resource allocation includes adjusting rendering fidelity and computational priority based on real-time assessment of the hardware capabilities of the communication device.

In some embodiments, the computing system integrates one or more machine learning models within the modular mixed reality engine. The one or more machine learning models are operable to analyze real-time interaction and environmental data.

In some embodiments, the one or more machine learning models execute within the modular mixed reality engine. The execution predicts user interaction patterns. Based on the prediction, the computing system pre-loads one or more corresponding mixed reality modules from the plurality of mixed reality modules. The pre-loading optimizes computational efficiency according to the hardware capabilities of the communication device.

In some embodiments, the pre-loading of the one or more mixed reality modules based on the prediction of the user interaction patterns is executed by the one or more processors. The one or more processors are configured for collecting real-time interaction data, historical interaction data, and environmental context data. In addition, the one or more processors are configured for training the one or more machine learning models using the historical data. The one or more machine learning models are trained continuously with an updated training dataset. Further, the one or more processors are configured for analyzing the collected real-time interaction data using the trained one or more machine learning models to identify user behavior patterns. The one or more processors are configured for predicting, the one or more trained machine learning models, one or more user actions based on the analysis. The one or more processors are configured for pre-loading the one or more mixed reality modules based on the predicted one or more user actions. The one or more processors are configured for continuously updating the predicted one or more user actions based on the real-time collected data.

In a second aspect, the present invention provides a computer-implemented method executed by one or more processors for dynamically rendering mixed reality (MR) content for rendering mixed reality (MR) content at a communication device. The method includes detecting a triggering action of a plurality of triggering actions for accessing the mixed reality (MR) content at a communication device. In addition, the method includes activating a modular mixed reality engine based on detection of the triggering action of the plurality of triggering actions at the communication device. The modular mixed reality engine includes a plurality of mixed reality (MR) modules. Moreover, the method includes recognizing a usage context associated with hardware capabilities of the communication device and environmental data in real time. Further, the method includes selecting at least one mixed reality (MR) module from a plurality of mixed reality (MR) modules based on one or more pre-defined criteria and the usage context. Next, the method includes dynamically loading the at least one selected mixed reality (MR) module through an instant application executed within a transient runtime environment on the communication device. Further, the method includes rendering the mixed reality (MR) content in real time on the communication device by executing one or more functionalities of the at least one selected mixed reality module. Furthermore, the one or more processors execute computer-executable instructions to improve functioning of the communication device through context-aware module selection, adaptive resource allocation, and sandboxed modular execution. Accordingly, the one or more processors execute the instructions to optimize resource utilization, reduce latency, enhance frame stability, and maintain spatial alignment. The dynamic loading of the at least one mixed reality module causes lightweight, real-time mixed reality rendering on devices with limited processing and memory resources.

In a third aspect, a non-transitory computer-readable medium is disclosed. The non-transitory computer-readable medium stores computer-executable instructions which, when executed by one or more processors of a computing device, cause the computing device to perform a method for dynamic and adaptive mixed reality content display. The method includes detecting a triggering action of a plurality of triggering actions for accessing the mixed reality (MR) content at a communication device. In addition, the method includes activating a modular mixed reality engine based on detection of the triggering action of the plurality of triggering actions at the communication device. The modular mixed reality engine includes a plurality of mixed reality (MR) modules. Moreover, the method includes recognizing a usage context associated with hardware capabilities of the communication device and environmental data in real time. Further, the method includes selecting at least one mixed reality (MR) module from a plurality of mixed reality (MR) modules based on one or more pre-defined criteria and the usage context. Next, the method includes dynamically loading the at least one selected mixed reality (MR) module through an instant application executed within a transient runtime environment on the communication device. Further, the method includes rendering the mixed reality (MR) content in real time on the communication device by executing one or more functionalities of the at least one selected mixed reality module. Furthermore, the computing system causes execution of context-aware module selection, adaptive resource allocation, and sandboxed modular execution for optimized graphical and computational resource usage, reduce rendering latency, and improves frame stability. In addition, the method causes seamless synchronization of one or more virtual elements with the real-world view for enhanced real-time mixed reality performance. Furthermore, the computer-executable instructions executed by the one or more processors improves operation of the computing device through context-aware module selection, adaptive resource allocation, and sandboxed modular execution adaptive resource allocation, context-aware module management, and sandboxed execution. The one or more processors execute the instructions to optimize computational efficiency and frame stability. The dynamic loading of the at least one mixed reality module causes deployment of lightweight, low-resource instant applications suited to the hardware capabilities of the communication device for efficient mixed reality content rendering on devices with limited computational capacity.

### BRIEF DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 illustrates an interactive computing environment for rendering a mixed reality (MR) content at a communication device, in accordance with various embodiments of the present disclosure;

FIG. 2 illustrates an exemplary distributed computing environment for rendering the mixed reality (MR) content at the communication device, in accordance with various embodiments of the present disclosure;

FIG. 3 illustrates an exemplary environment for enabling trigger-based instantiation and modular deployment of mixed reality (MR) content, in accordance with various embodiments of the present disclosure;

FIG. 4 illustrates a flow chart of a method for rendering the mixed reality (MR) content at the communication device, in accordance with various embodiments of the present disclosure; and

FIG. 5 illustrates a block diagram of an exemplary device configured for rendering the mixed reality (MR) content on the communication device, in accordance with various embodiments of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote features throughout the specification and figures.

### DETAILED DESCRIPTION

In the following description of the disclosure and embodiments, reference is made to the accompanying drawings in which it is shown by way of illustration of specific embodiments that can be practiced. It is to be understood that other embodiments and examples can be practiced, and changes can be made without departing from the scope of the disclosure.

Although the following description uses the terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input can both be outputs and, in some cases, can be separate and different inputs.

The terminology used in the description of the various described examples herein is for the purpose of describing specific examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

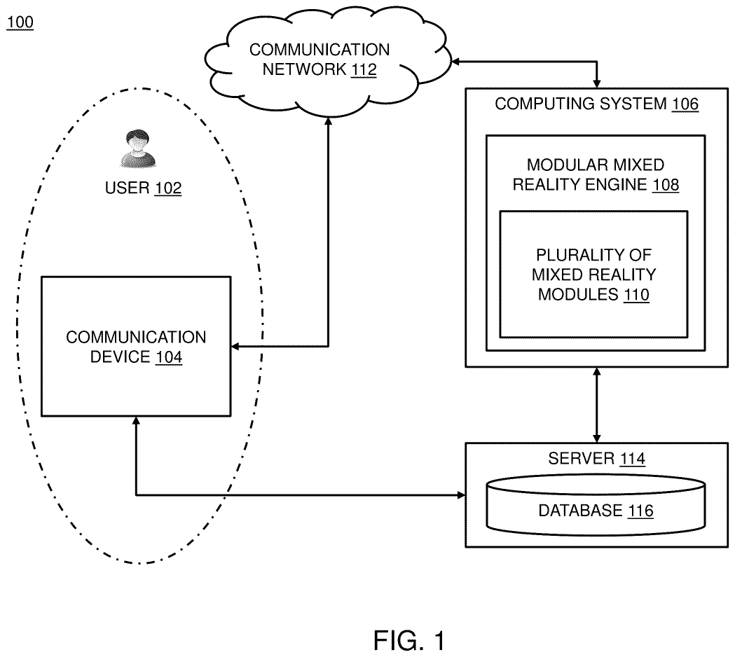

FIG. 1 illustrates an interactive computing environment 100 for rendering mixed reality (MR) content at a communication device 104, in accordance with various embodiments of the present disclosure. The interactive computing environment 100 includes a communication device 104 associated with a user 102, a computing system 106, a communication network 112, a server 114 and a database 116. The communication device 104 interacts with the computing system 106 via the communication network 112. The components of the interactive computing environment 100 cooperate to render a mixed reality experience on the communication device 104. The components of the interactive computing environment 100 are operatively coupled and cooperatively function to cause dynamic deployment, and rendering of the mixed reality (MR) content tailored to contextual and device-specific conditions.

The mixed reality experience refers to a digitally enhanced immersive environment that blends virtual objects or augmentations with the physical world or environment in real time. The mixed reality experience allows the user 102 to perceive and interact with at least one or more digital and one or more physical components in a spatially and temporally coherent manner. The mixed reality content encompasses at least digital assets, virtual objects, holograms, spatial audio, interactive controls, and context-sensitive information rendered within the mixed reality experience. The mixed reality content is rendered in real time based on user input, environmental conditions, sensor data, and device capabilities. In addition, the mixed reality content includes dynamic overlays, gesture-responsive elements, or real-world object annotations.

In some embodiments, the communication device 104 refers to any suitable user equipment operable to receive, render, and interact with the mixed reality content. Examples of the communication device 104 include a smartphone, tablet, smart glasses, wearable computing device, augmented reality (AR) headsets, and the like. Additionally, the communication device 104 may host a runtime environment capable of executing instant or transient mixed reality modules without requiring full application installation.

The user 102 may represent an individual interacting with the mixed reality (MR) content through the communication device 104. The user 102 may initiate mixed reality experiences by scanning a Quick Response (QR) code, clicking an app link, or triggering the modular mixed reality engine 108 via other scannable or link-based mechanisms.

The mixed reality rendering process begins when the communication device 104 detects one or more triggering actions from a plurality of triggering actions. The one or more triggering actions may include scanning a Quick Response (QR) code, selecting a hyperlink, or detecting a near-field communication (NFC) tag. Each of the plurality of triggering actions is embedded with metadata that provides device-specific parameters such as available memory, processor class, and sensor configuration. The computing system 106 utilizes the metadata to select and load only one or more corresponding MR modules 110 compatible with the hardware capabilities of the communication device 104. The selection based loading ensures efficient resource usage even on low-end or mid-tier hardware.

Upon detection of a valid trigger, the modular mixed reality engine 108 is activated and initializes a secure execution framework. The framework allocates a sandboxed runtime environment that prevents cross-module interference and causes secure, isolated execution of lightweight MR modules.

The computing system 106 may include one or more processors, memory units, and a rendering engine operable to generate and deliver the mixed reality content to the communication device 104. The rendering engine may leverage spatial mapping data, object recognition modules, or user-specific behavioral profiles to adapt the mixed reality content in real time. Additionally, the communication network 112 may include wired or wireless channels, such as 5G, Wi-Fi, or satellite links, to facilitate low-latency content synchronization and interaction. The server 114 may manage user sessions, content orchestration, and system-wide updates, while the database 116 may store user profiles, contextual data, device parameters, and pre-rendered or modular content components.

In some embodiments, the computing system 106 includes a modular mixed reality engine 108. The modular mixed reality engine 108 includes a plurality of mixed reality modules 110. The modular mixed reality engine 108 orchestrates loading of at least one module of the plurality of mixed reality modules 110 in real-time. The dynamic loading of the at least one module is done based at least on one or more user interactions and environmental data. The dynamic loading feature ensures an optimized performance and user experience. In an implementation, the modular mixed reality engine 108 may be a modular and platform-agnostic MR engine. The computing system 106 allows seamless deployment of the mixed reality content by leveraging real-time context awareness, dynamic module loading, and lightweight instant applications.

In some other embodiments of the present disclosure, the modular mixed reality engine 108 may orchestrate unloading of at least one module of the plurality of mixed reality modules 110 in real-time. The dynamic unloading of the at least one module is done based at least on one or more user interactions and environmental data. The dynamic loading feature ensures an optimized performance and user experience. In an implementation, the modular mixed reality engine 108 may be a modular and platform-agnostic MR engine. The computing system 106 allows seamless deployment of the mixed reality content by leveraging real-time context awareness, dynamic module loading, and lightweight instant applications.

The plurality of mixed reality modules 110 operate within a kernel-level application sandbox or a secure sandbox environment in a Linux-based system to provide security and efficiency. In some embodiments, the secure sandbox environment is established through context-aware permission management and a secure execution framework. The secure sandbox environment ensures at least security and stability during the rendering of the mixed reality content.

The dynamic loading mechanism implemented within the secure execution framework allows the plurality of mixed reality modules 110 to be loaded, executed, and unloaded on demand. Each module is modular and independently deployable. The communication device 104 does not require permanent installation of full MR applications. Instead, the modular mixed reality engine 108 retrieves only the minimal executable components required for a given session. The architecture supports lightweight, instant-access MR experiences with a typical footprint in the range of hundreds of kilobytes, to cause operation on devices with limited storage or processing power. The sandboxed runtime environment isolates each of the plurality of mixed reality module 110 at the kernel level, to ensure both computational efficiency and security. The computing system 106 dynamically redistributes CPU and GPU cycles based on real-time workload, performing adaptive resource allocation to maintain visual stability, minimize latency, and prevent frame drops during high-load operations.

In an embodiment of the present invention, the computing system 106 performs adaptive data streaming for adjusting data streaming rates based on network conditions and device performance while integrating edge computing for efficiency. In some embodiments, the computing system 106 performs a cross-module communication for facilitating real-time data exchange between at least two modules of the plurality of mixed reality modules 110. In addition, the cross-module communication enhances realism of the mixed reality experience through seamless interaction between 2D alpha content and 3D environment mapping.

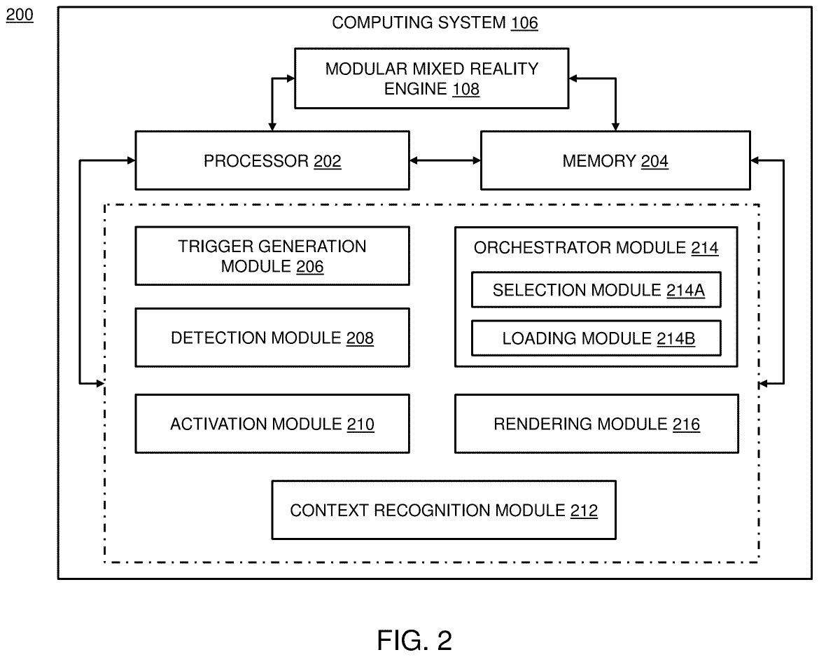

The communication device 104 works in conjunction with the computing system 106, the server 114 and the modular mixed reality engine 108 to perform a set of functions. The set of functions includes at least reception of contextual data, dynamically loading appropriate mixed reality modules, and rendering immersive content responsive to real-time user interactions and environmental conditions (explained below in the detailed description of FIG. 2).

The communication network 112 serves as the backbone of the interactive computing environment 100, enabling seamless communication between the communication device 104, the computing system 106, the server 114 and the database 116. Various entities in the environment 100 may connect to the communication network 112 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G), 6th Generation (6G) communication protocols, Long Term Evolution (LTE) communication protocols, future communication protocols or any combination thereof.

The communication network 112 provides an infrastructure for seamless communication between the communication device 104, the computing system 106, the server 114 and the database 116. In some implementations, the communication network 112 includes internet, intranet, Wi-Fi, or other wired or wireless communication technologies.

The server 114 may refer to a backend processing system or a cloud-based infrastructure operable to coordinate, manage, and support the delivery of mixed reality (MR) content to the communication device 104. In some embodiments, the server 114 includes one or more computing devices operable to manage backend operations. The operations include but are not limited to, processing user requests, storing and updating MR content modules, and executing cloud-based rendering operations. In addition to above, the server 114 may manage user sessions and maintain communication with the communication device 104. The server 114 may incorporate application programming interfaces (APIs), load-balancing modules, analytics engines, and orchestration logic to dynamically coordinate mixed reality experiences across users and devices.

In some embodiments, the server 114 is associated with one or more remote computing entities. The one or more remote computing entities are responsible for facilitating core services required for managing and supporting the delivery of the mixed reality (MR) experiences. The server 114 operates as an orchestrator that communicates with the computing system 106 and the communication device 104 over the communication network 112. In one example, the server 114 may host APIs, decision engines, and application services operable to process user interactions, manage MR session states, authenticate user access, and deliver relevant MR content modules to downstream components.

In certain implementations, the server 114 may enforce access controls, implement deployment policies, and manage caching of frequently accessed MR assets to enhance responsiveness and delivery speed. The server 114 plays a key role in mediating communication between the modular mixed reality engine 108 on the communication device 104 and the backend infrastructure. The server 114 performs seamless synchronization and dynamic loading of mixed reality modules across heterogeneous client platforms.

In some embodiments, the server 114 and the computing system 106 are architecturally distinct but interoperable components of the interactive computing environment 100. The server 114 and the computing system 106 perform complementary functions to facilitate MR content delivery and interaction. The server 114 acts as a backend orchestrator and processing layer, implemented using centralized or distributed cloud resources. It is operable to manage session states, execute intensive computational operations such as spatial computation and scene analysis, personalize MR content, and transmit context-aware MR assets to client-side rendering components.

The server 114 may refer to a backend processing system or cloud-based infrastructure that coordinates, manages, and supports the rendering of the mixed reality (MR) content delivered to the communication device 104. In some embodiments, the server 114 and the computing system 106 represent architecturally distinct yet interoperable components of the interactive computing environment 100. Each of the server 114 and the computing system 106 are operable to perform complementary functions in support of the mixed reality (MR) content delivery and interaction. The server 114 functions as a backend processing and orchestration layer, implemented as a cloud-based infrastructure or centralized computing resource. The server 114 is operable to manage user sessions, perform computationally intensive operations such as spatial computation, scene understanding, and MR content personalization, and deliver contextually relevant MR assets to client-side components.

The server 114 may host, manage and remotely execute an instant application mechanism for enabling the dynamic delivery of one or more mixed reality modules and ensuring platform and device independent user experiences. The server 114 may serve as an edge computing or localized processing layer that interfaces directly with the communication device 104. The server 114 is operable to handle real-time operations. The operations include at least adaptive user interface control, haptic feedback coordination, sensor data ingestion, and latency-sensitive mixed reality content rendering.

In an example implementation of a distributed computing environment and shown in FIG. 1, the computing system 106 is operatively connected to the server 114. The server 114 hosts a database 116. The server 114 handles client requests and provides necessary data to the computing system 106 for processing and rendering of mixed reality content. The computing system 106 and the server 114 are communicatively coupled via the communication network 112. The computing system 106 and the server 114 cooperatively function to perform scalable, immersive, and responsive mixed reality experiences across heterogeneous devices and usage contexts.

In another example implementation, the computing system 106 includes or is operatively connected to the database 116 for storing localized content or cached user session data (not shown in illustration). The computing system 106 includes a modular mixed reality engine 108 and is operatively connected to the server 114 hosting the database 116. The server 114 handles client requests and provides necessary data to the computing system 106 for processing and rendering of mixed reality content.

The computing system 106 may include a combination of software components, processing units, micro services, or virtualized containers that handle multiple tasks. The tasks include module selection, compatibility evaluation, mixed reality asset delivery, spatial computation, and the like. The computing system 106 herein may represent a cloud server, an edge computing node, or a centralized processing system. In some embodiments, the computing system 106 includes the database 116. In some other embodiments, the database 116 is associated and remotely connected to the computing system 106. In one implementation, the computing system 106 may include one or more server-grade machines or distributed cloud-based computing resources operable to perform the rendering of the mixed reality (MR) content. The computing system 106 may include a plurality of software modules and processing components operative to execute the rendering of the mixed reality (MR) content. In an example implementation scenario, the rendering may include data pre-processing, feature extraction, segmentation model inference, and post-processing operations.

The database 116 refers to one or more data storage systems that store structured and unstructured information necessary for supporting and rendering the mixed reality experience. In one embodiment, the database 116 herein may correspond to a non-transitory storage system caused to persistently store real time information for the rendering of the mixed reality content. The database 116 may include at least mixed reality module repositories, user profiles, mixed reality experience identifiers (IDs), device compatibility matrices, content metadata, and environmental context logs. In addition, the database 116 may contain pre-trained machine learning models used for dynamic prediction of mixed reality modules. The database 116 performs real-time data retrieval and synchronization across the computing system 106 and the server 114 to ensure that relevant mixed reality assets are efficiently selected, delivered, and rendered at the communication device 104. The database 116 may be implemented as a distributed cloud database or a hybrid architecture to support scalability, redundancy, and low-latency data access.

The database 116 herein may correspond to a collection of information that is organized so that it can be easily accessed, managed and updated. In some implementations, the database 116 may include relational databases, NoSQL databases, cloud-based databases, graph databases, in-memory databases, and the like.

In one embodiment, the server 114 exists as an external host for the computing system 106 (as shown in FIG. 1). The database 116 may be integrated within the server 114. In some other embodiments, the server 114 may host the computing system 106 (not shown in FIG. 1). The database 116 may be integrated within the server 114 for retrieving at least mixed reality assets, spatial data, and user interaction logs.

It is shown in FIG. 1 that a single user (the user 102) interacts with a single device (the communication device 104); however, it will be appreciated by those skilled in the art that any number of users can simultaneously interact with the corresponding devices in real-time.

The number and arrangement of systems, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the interactive computing environment 100 may perform one or more functions described as being performed by another set of systems or another set of devices of the interactive computing environment 100.

FIG. 2 illustrates an exemplary block diagram 200 of the computing system 106 for rendering the mixed reality (MR) content at the communication device 104, in accordance with various embodiments of the present disclosure. Please note that in order to explain system elements of FIG. 2, references might be made to the system elements of FIG. 2 for clarity and ease.

The computing system 106 includes a processor 202, a memory 204 and the modular mixed reality engine 108. In addition, the computing system 106 includes a trigger generation module 206, a detection module 208, an activation module 210 and a context recognition module 212. Additionally, the computing system 106 includes an orchestrator module 214, a rendering module 216 and a data streaming module 218. Moreover, the orchestrator module 214 includes a selection module 214a and a loading module 214b. It should be noted that the above mentioned system elements are exemplary system elements; however, there may be more system elements for the computing system 106.

The memory 204 stores instructions that, when executed, cause the processor 202 to be operable to perform rendering of the mixed reality (MR) content at the communication device 104. The processor 202 is in communication with the modular mixed reality engine 108, the detection module 208, the activation module 210 and the context recognition module 212. Additionally, the processor 202 is in communication with the orchestrator module 214, the rendering module 216 and the data streaming module 218.

In one embodiment, the computing system 106 includes the modular mixed reality engine 108 operable to execute a plurality of mixed reality modules 110 stored in a non-transitory memory 204. The one or more processors 202 execute the plurality of mixed reality modules 110. The modular mixed reality engine 108 serves as a hardware-integrated software framework that orchestrates module activation, adaptive rendering, and resource coordination during real-time execution of mixed reality (MR) experiences.

The elements of the computing system 106 collectively work in synchronization to enable the user 102 to access the mixed reality experience. The mixed reality experience is deployed in a distributed computing environment. The distributed computing environment includes a user communication device, a local execution system with a modular mixed reality engine, and a backend server operably coupled with a database. The computing system 106 is executed locally via a transient runtime on the user device and is operable to selectively render MR content based on metadata and instructions received from the server in response to one or more triggering actions.

In an embodiment of the present disclosure, execution of the computer-executable instructions stored in the non-transitory memory 204 by the one or more processors 202 improves the operation of the communication device 104 by reducing computational cycles required for the real-time rendering of the one or more virtual elements. The improvement is achieved through adaptive resource allocation. The one or more processors dynamically evaluate the hardware capabilities of the communication device 104, such as CPU utilization, GPU bandwidth, and memory availability, during the mixed reality content rendering. Based on the assessment, the computing system 106 adjusts the rendering fidelity and the computational priority in real time to allocate the processing tasks efficiently across the available hardware subsystems.

In an embodiment, the adaptive resource allocation performed by the processor 202 reduces redundant processing cycles and optimizes the scheduling of the rendering operations between the CPU and GPU. The computing system 106 prioritizes critical rendering and tracking processes and defers non-critical graphical updates to maintain balanced processor utilization. The intelligent workload distribution enhances frame stability and minimizes latency associated with the real-time mixed reality display. As a result, the communication device 104 achieves measurable improvements in computational throughput and graphical synchronization, to enable smooth and consistent rendering performance even on devices with limited processing and memory resources.

The processor 202 executes one or more instructions stored in the memory 204 for enabling the user 102 to access the mixed reality content on the communication device 104.

The trigger generation module 206 is operable to generate a plurality of access triggers. The plurality of access triggers include an image trigger, a URL trigger, a scannable code based trigger (a Quick Response (QR) code), a video trigger, and the like. The trigger generation module 206 generates universal links compatible with any device, regardless of operating system. The trigger generation module 206 generates Uniform Resource Locators (URLs) or Uniform Resource Identifiers (URIs) adhering to standard web protocols. The generated Uniform Resource Locators (URLs) or the Uniform Resource Identifiers (URIs) ensure compatibility across Android, iOS, Windows, and web browsers.

The processor 202 executes an instruction that causes the detection module 208 to detect a triggering action of a plurality of triggering actions for accessing the mixed reality (MR) content at the communication device 104. The plurality of triggering actions correspond to executing or initiating access to the mixed reality content via execution of an access trigger of the plurality of access triggers. The plurality of triggering actions includes but may not be limited to scanning a Quick Response (QR) code, clicking a hyperlink, detecting a near-field communication (NFC) tag, receiving a voice command, or recognizing a gesture input. In some embodiments, the Quick Response (QR) code may be captured through one or more cameras of the communication device 104, decoded, and utilized to extract metadata required for initializing the modular mixed reality engine 108.

Each of the plurality of triggering actions serve as a means for the user 102 to initiate access to a mixed reality (MR) content using the communication device 104. In some embodiments, the plurality of triggering actions corresponds to a mode for initiating a device-agnostic and platform-agnostic access to the mixed reality (MR) content. The device-agnostic and platform-agnostic access refers to enabling access to the mixed reality (MR) content independently of a specific type, make, model, or operating system of the communication device. The computing system 106 enables access across a heterogeneous set of user devices, without requiring device-specific configurations or adaptations to perform a hardware or platform independent access to the mixed reality content.

The plurality of triggering actions includes but may not be limited to scanning a Quick Response (QR) code, clicking a hyperlink, detecting a near-field communication (NFC) tag, receiving a voice command, or recognizing a gesture input. In one embodiment, the Quick Response (QR) code may be captured through one or more cameras of the communication device 104, decoded, and utilized to extract metadata required for initializing the modular mixed reality engine 108. In some embodiments, the scanning of the Quick Response (QR) code includes capturing an image of the Quick Response (QR) code using the camera module of the communication device 104, decoding the captured image to extract encoded information, and using the extracted information to initiate activation of the modular mixed reality engine.

In some embodiments, each of the plurality of triggering actions includes the embedded metadata. The metadata includes device-specific parameters corresponding to the hardware capabilities of the communication device 104 to perform adaptive loading of lightweight mixed reality modules. The metadata includes at least one of a mixed reality (MR) experience identifier, asset locations, and one or more parameters controlling the mixed reality (MR) experience.

In some embodiments, clicking on the hyperlink received on the communication device facilitates initiating a process of loading metadata linked to the hyperlink for activating the modular mixed reality engine. The metadata includes at least one of a mixed reality (MR) experience identifier, asset locations, and one or more parameters controlling the mixed reality (MR) experience. In some embodiments, detection of the NFC tag through the communication device includes establishing a near-field communication session, retrieving data stored on the NFC tag and utilizing the retrieved data to activate the at least one selected modular mixed reality engine.

In one embodiment, each of the plurality of triggering actions includes a universal access link compatible with the hardware capabilities of the communication device and the environment data. The universal access link includes metadata embedded in at least one of the plurality of triggering actions. Each link contains embedded metadata. The metadata includes at least one of a mixed reality (MR) experience identifier, asset locations, and one or more parameters controlling the mixed reality (MR) experience.

In one embodiment, the trigger generation module 208 embeds these links into mediums like Quick Response (QR) codes, NFC tags, or hyperlinks sent via messaging platforms. For example, a museum uses the module to create Quick Response (QR) codes placed next to exhibits, allowing visitors to scan the codes and instantly access MR experiences related to each exhibit without installing any apps.

The scanning of the Quick Response (QR) code includes capturing an image of the Quick Response (QR) code using the camera module of the communication device 104. Also, scanning of the Quick Response (QR) code includes decoding of the captured image to extract encoded information and initiate activation of the modular mixed reality engine 108 using the extracted information. Further, clicking on the hyperlink received on the communication device facilitates initiating a process of loading metadata linked to the hyperlink for activating the modular mixed reality engine 108. Also, detection of the NFC tag through the communication device 104 includes establishing a near-field communication session, retrieving data stored on the NFC tag, and utilizing the retrieved data to activate the at least one selected modular mixed reality engine 108.

The processor 202 executes an instruction that causes the activation module 210 to activate the modular mixed reality engine 108 based on detection of the triggering action of the plurality of triggering actions at the communication device 104. Upon activation, the modular mixed reality engine 108 initiates a context-aware process that performs recognizing a usage context associated with hardware capabilities of the communication device 104 and environmental data in real time. The modular mixed reality (MR) engine 108 performs cross-module communication between dynamically loaded mixed reality (MR) modules. The cross-module communication facilitates real-time synchronization of at least 2D and 3D virtual content, rendering states, and user interactions across the plurality of mixed reality (MR) modules. The cross-module communication is based on one of a camera input, gesture input, a touch input and contextual data to deliver an immersive and adaptive mixed reality experience.

The computing system 106 executes a trigger-based Mixed Reality (MR) activation method for enabling the seamless delivery of the mixed reality (MR) content across multiple platforms. The computing system 106 is operable to utilize real-time adaptation of 3D content based on input from one or more hardware sensors. Furthermore, the computing system 106 employs data optimization techniques, such as content size reduction and integration of edge computing for improved efficiency in data delivery. In one embodiment, the computing system 106 may include a feedback loop mechanism. The feedback loop mechanism enables real-time optimization of the mixed reality experience for significantly improving overall user engagement and interaction.

In an implementation, the computing system 106 interacts with the server 114 and the database 116 to retrieve mixed reality experience metadata, user profiles, and relevant configuration parameters. The computing system 106 dynamically determines at least one mixed reality module of the plurality of mixed reality modules 110 suitable for deployment. Furthermore, the computing system 106 may generate or update a spatial map of physical environment of the user 104, orchestrate adaptive rendering instructions, and transmit an optimized mixed reality content to the communication device 104 in real time. The computing system 106 ensures efficient module delivery, manages runtime execution environments, and helps maintain cross-platform consistency across heterogeneous devices. In some embodiments, the computing system 106 operates based on real-time inputs received from the communication device 104. The real-time inputs include at least one of device specifications, environmental context, and user behavior.

Furthermore, the processor 202 executes an instruction that causes the context recognition module 212 to recognize a usage context. The usage context is recognized based on hardware capabilities of the communication device 104 and environmental data in real time. In addition, the processor 202 is operable to continuously assess device resource availability based on a set of parameters. The set of parameters includes at least CPU utilization, GPU utilization, battery state, network state and thermal limits. Prior to recognizing the usage context, the processor 202 is operable to capture the usage context through a camera module of the communication device 104.

In some embodiments, the usage context is determined by evaluating a plurality of parameters corresponding to the hardware capabilities of the communication device 104. The plurality of parameters includes at least one of CPU utilization, GPU utilization, memory availability, network conditions, thermal thresholds or battery condition of the communication device 104 to dynamically control module selection and resource allocation. In some embodiments, the plurality of mixed reality (MR) modules 110 includes a flat image tracking module, a curved image tracking module, a ground tracking module, and an object tracking module. Each of the plurality of mixed reality modules 110 is associated with one or more pre-defined functionalities configured for the dynamic loading, execution, and unloading of the plurality of mixed reality modules 110 according to the hardware capabilities of the communication device 104. In some embodiments, the adaptive resource allocation includes adjusting rendering fidelity and computational priority based on real-time assessment of the hardware capabilities of the communication device 104.

Next, the processor 202 executes an instruction that causes the selection module 214a of the dynamic orchestrator module 214 to select at least one mixed reality (MR) module from the plurality of mixed reality (MR) modules 110. The selection module 214a selects the at least one mixed reality (MR) module based on one or more pre-defined criteria and the usage context. In one embodiment, the one or more pre-defined criteria include at least one of a type of the communication device 104, the hardware capabilities of the communication device 104, operating system specifications of the communication device 104, types of sensors in the communication device 104, and rendering capacity of the communication device 104.

In one embodiment, the plurality of mixed reality (MR) modules 110 includes at least a flat image tracking module, a curved image tracking module, a ground tracking module, and an object tracking module. Each of the plurality of mixed reality (MR) modules 110 is operable to render the mixed reality (MR) content on the communication device 104 in real time. Each of the plurality of mixed reality modules 110 is associated with one or more pre-defined functionalities configured for dynamic loading, execution, and unloading based on contextual requirements.

After activation, the modular mixed reality engine 108 communicates with the server 114, which acts as a backend orchestration entity. The server 114 is operable to receive and analyze the usage context data from the communication device 104 and select suitable mixed reality modules from the plurality of mixed reality (MR) modules 110. The modular mixed reality engine 108 is operable to communicate with the plurality of MR modules 110, each designed to provide specific MR functionalities. The modular mixed reality engine 108 includes the plurality of MR modules 110. In an example, the flat image tracking module may be utilized to anchor a digital poster onto a flat magazine cover detected through the camera module. In addition, the curved image tracking module may render a label conforming to curvature of a cylindrical bottle. Further, the ground tracking module may place a virtual furniture object on the floor surface. The object tracking module may detect and augment a physical toy car with animated overlays, enabling interaction as the car moves within the camera's field of view.

The processor 202 executes an instruction that causes the loading module 214b of the dynamic orchestrator module 214 to dynamically load the at least one selected mixed reality module. The processor 202 dynamically loads the at least one selected mixed reality module into a secure execution framework. In an embodiment, the secure execution framework corresponds to a kernel-level sandboxed environment executed through an instant application mechanism. The instant application mechanism includes temporarily deploying an instant application on the communication device 104. In one embodiment, the instant application has a pre-defined size ranging from 900 kilobytes to 1.2 megabytes. The orchestrator module 214 dynamically loads the mixed reality (MR) modules in real time based on context inferred from the user input and environmental data, with modules operating within the kernel-level application sandbox in a Linux-based system to ensure both performance and security.

In some embodiments, the processor 202 is operable to determine whether the selected mixed reality module is to be loaded on the communication device 104 based on evaluating compatibility of the plurality of mixed reality (MR) modules with one or more features of the communication device in real time. The processors 202 determines a selection of a particular module prior to dynamically loading the at least one selected mixed reality (MR) module into the secure execution framework.

In some embodiments, the modular mixed reality engine 108 enables cross-module communication. In an example, the cross-module communication facilitates real-time data exchange between the plurality of MR modules 110, ensuring seamless interaction between 2D alpha content and 3D environment mapping.

In one embodiment, the processor 202 incorporate the one or more machine learning models within the modular mixed reality engine 108. The one or more machine learning models are operable to analyze real-time interaction and environmental data. In some embodiments, the one or more machine learning models execute within the modular mixed reality engine 108. The one or more machine learning models predict the user interaction patterns. Based on the prediction, the computing system 106 pre-loads the one or more corresponding mixed reality modules from the plurality of mixed reality modules 110. The pre-loading optimizes computational efficiency according to the hardware capabilities of the communication device 104.

In one embodiment, the one or more machine learning models are operable to analyze the user interaction data, environmental conditions, and historical usage patterns. The one or more machine learning models predict upcoming user actions, such as expected gestures, focus points, or navigation paths. Accordingly, the one or more machine learning models transmit the prediction output to the loading module 214b. The loading module 214b pre-loads corresponding one or more mixed reality modules before the user interaction occurs. The predictive pre-loading minimizes the perceived latency and enables the adaptive rendering behavior suited to user behavior and hardware context.

The one or more machine learning models are trained continuously using real-time and historical data to refine the prediction accuracy. The one or more machine learning models operate within the modular mixed reality engine 108, for leveraging hardware acceleration for neural inference through on-device AI processors or GPU cores. The hardware acceleration ensures that the adaptive behaviors yield tangible improvements in responsiveness and energy efficiency.

In one embodiment, the pre-loading of the one or more mixed reality modules based on the prediction of the user interaction patterns is executed by the one or more processors. The one or more processors are configured for collecting the real-time interaction data, the historical interaction data, and the environmental context data. In addition, the one or more processors are configured for training the one or more machine learning models using the historical data. The one or more machine learning models are trained continuously with an updated training dataset. Further, the one or more processors are configured for analyzing the collected real-time interaction data using the trained one or more machine learning models to identify user behavior patterns. The one or more processors are configured for predicting, using the one or more trained machine learning models, one or more user actions based on the analysis. The one or more processors are configured for pre-loading the one or more mixed reality modules based on the predicted one or more user actions. The one or more processors are configured for continuously updating the predicted one or more user actions based on the real-time collected data.

The processor 202 executes an instruction that causes the rendering module 216 to render the mixed reality (MR) content in real time on the communication device 104 using the selected at least one selected mixed reality module. The rendering is done by deploying the secure execution framework on the communication device 104. In some embodiments, the secure execution framework corresponds to an instant application executed within a transient runtime environment on the communication device 104. The mixed reality (MR) content is rendered on the communication device 104 in real time through the kernel-level sandboxed environment.

During rendering, the modular mixed reality engine 108 fuses sensor data, positional information, and virtual content streams to superimpose one or more virtual elements on the real-world view displayed through the camera module 104a of the communication device 104. The rendering optimization is performed through the real-time adjustment of rendering fidelity, depth alignment, and occlusion handling. The modular framework ensures that each loaded MR module communicates directly with hardware drivers to access most efficient rendering path available on the specific device platform. The computing system 106 continuously evaluates frame-level performance metrics, such as average render time and GPU load, to dynamically rebalance resource distribution between graphical and computational tasks. The closed feedback loop allows the computing system 106 to maintain seamless spatial alignment between the virtual and the physical elements to improve frame stability and reduce rendering latency.

In an embodiment of the present disclosure, execution of the computer-executable instructions stored in the non-transitory memory 204 by the one or more processors 202 improves the operation of the communication device 104 by reducing the computational cycles required for the real-time rendering of the one or more virtual elements. The improvement is achieved through the adaptive resource allocation. The processor 202 continuously assesses the hardware parameters of the communication device 104, such as CPU utilization, GPU bandwidth, and memory availability. Based on the real-time assessment, the computing system 106 dynamically adjusts the rendering fidelity and computation priority across different hardware subsystems of the communication device 104. The adaptive management of hardware resources optimizes processor utilization, minimizes redundant computation, and maintains efficient execution during mixed-reality rendering operations.

In an embodiment, the adaptive resource allocation performed by the processor 202 further enhances system responsiveness and graphical stability. The processors 202 is caused to execute an instruction for intelligently distributing workloads between the CPU and the GPU according to the detected hardware capabilities of the communication device 104. Based on the workload distribution, the computing system 106 reduces frame-level latency and prevents processing bottlenecks. The critical rendering tasks include spatial tracking and virtual-element synchronization. The critical rendering tasks are executed with higher priority, and non-critical updates are selectively deferred to maintain consistent frame pacing. The coordinated execution across processing subsystems improves computational throughput and frame synchronization to cause the processor 202 to perform smooth real-time rendering of the mixed-reality content on communication devices with limited processing and memory capacity.

To render the mixed reality (MR) content, the processor 202 is operable to render at least one digital object or the one or more virtual elements within the physical environment on a display of the communication device 104 based on the spatial map. The digital object is visually aligned with a real-time camera view captured by the camera module of the communication device 104.

The modular mixed reality engine 108 selects one or more suitable mixed reality modules from the plurality of mixed reality modules 110 based on predefined selection criteria and the derived usage context. The pre-defined selection criteria may include device type, operating system specifications, rendering capability, and sensor availability.

Once selected, the selected mixed reality module(s) are dynamically loaded onto the communication device 104 through an instant application mechanism. In an embodiment, the instant application has a pre-defined size ranging from 900 kilobytes to 1.2 megabytes. In some other embodiments of the present disclosure, the pre-defined size range of the instant application may vary. The instant application provides temporary execution without requiring installation, thus enabling efficient and scalable deployment across heterogeneous device environments. For instance, in a city navigation MR app, when a user points their device at a landmark, the computing system 106 dynamically loads the module responsible for overlaying historical information. As the user moves away, this module is unloaded, and a module for general navigation is loaded instead.

Upon successful deployment, the selected mixed reality module renders the mixed reality content in real time on the communication device 104. To render, the selected mixed reality module may perform placement of digital objects within the user's physical environment based on a spatial map generated from camera input captured from the one or more cameras of the communication device 104. The spatial map of the physical environment is generated by applying computer vision algorithms on the camera input. The spatial map of the physical environment represents surfaces, objects, and the user context. The spatial map is continuously updated in real-time. The rendered MR content may include alpha channel video overlays, interactive 3D objects, or other visual elements aligned with the device's real-time camera feed. The alpha channel video overlays are responsive to various user inputs, including touch, voice, motion, gaze, and gestures.

In an embodiment of the present invention, the alpha channel video overlays allow a transparent video to be superimposed on the real-world view captured by a camera module of the communication device 104. The alpha channel video overlay may be used to add virtual elements to the environment or enhance existing features. Key features include transparency support, utilizing videos with an alpha channel to render transparent or semi-transparent overlays, real-time rendering, where overlays are adjusted to the camera's perspective and movement, and virtual element integration, allowing overlays to represent virtual objects, characters, or informational content that seamlessly blend with the real world. For instance, in an MR shopping app, a user can see how a piece of furniture would look in their room by viewing a transparent 3D model overlaid on their camera feed, or by viewing an experience for an advertisement in a newspaper.

Furthermore, the MR content is anchored persistently within the physical environment such that digital objects maintain their spatial orientation and positioning even as the communication device 104 moves, thereby providing a consistent and immersive MR experience. The digital object is visually aligned with a real-time camera view captured by the one or more cameras of the communication device 104.

To enhance security and performance, the plurality of MR modules 110 are executed within a secure sandboxed environment at a kernel level of a Linux-based operating system of the communication device 104.

Further, the computing system 106 is operable to enable seamless playback of the rendered MR content on the communication device 104. The seamless playback is ended through continuous optimization of resource utilization of the communication device 104. Also, the processor 202 is operable to enable seamless playback of the rendered mixed reality (MR) content on the communication device 104. The seamless playback is enabled through a continuous optimization of resource utilization of the communication device 104.

In one embodiment, the modular mixed reality engine 108 dynamically loads/unloads the mixed reality modules based on user interactions and environmental data. In an example, only relevant mixed reality components are active at any given time, which optimizes memory and compute resource usage, reducing lag or delay in rendering. The real-time orchestration prevents bottlenecks and enables continuous, uninterrupted MR experiences.

In one embodiment, the computing system 106 is operable to deliver a seamless, platform-agnostic mixed reality (MR) experience that is dynamically adaptive and optimized for performance. An architecture of the computing system 106 includes several key components. The components ensure a smooth delivery and interaction of the mixed reality (MR) content across various devices and platforms (explanation disclosed in the detailed description of FIG. 2).

In some embodiments, the plurality of mixed reality modules 110 execute in a secure and efficient sandbox at the kernel level on a Linux-based system. This isolated yet lightweight execution environment allows fast context-switching between the mixed reality modules and prevents performance degradation, contributing to smooth playback.

In one embodiment, the processor 202 executes an instruction for dynamically optimizing a loading sequence of one or more mixed reality components. The loading sequence is optimized by executing a series of steps. The series of steps includes a first step of collecting data associated with at least real-time user interaction data and environmental context. The series of steps includes a second step of analyzing the collected data using one or more machine learning models to identify user behavior patterns. The series of steps includes a third step of predicting one or more user actions based on the analysis. The series of steps includes a fourth step of pre-loading the one or more mixed reality components associated with the predicted one or more user actions. The series of steps includes a fifth step of continuously updating the predicted one or more user actions based on the real time collected data. The predictive pre-loading enables reduced latency and enhances responsiveness of the mixed reality content.

In some embodiments, the computing system 106 provides a platform-agnostic mixed reality (MR) experience through a dynamic, real-time, and adaptive process. In one embodiment, activation is facilitated via app links, Quick Response (QR) codes, or other scannable media containing metadata linked to an MR experience identifier (ID). The activation triggers the communication device 104 to download necessary assets, launch the mixed reality experience, and dynamically adapt 3D content in the mixed reality experience.

The 3D content is dynamically adapted using an input data from one or more of a camera sensor and a depth sensor of the communication device 104.

The 3D content is dynamically adapted using an input data from one or more hardware sensors of the communication device 104. The one or more hardware sensors include at least an accelerometer and a gyroscope.

In an embodiment of the present invention, the computing system 106 enhances user immersion and responsiveness through an Adaptive User Interface (UI) and Haptic Feedback System. The Adaptive User Interface (UI) refers to a dynamically configurable user interface at the communication device 104. The dynamically configurable user interface corresponds to a modified user interface for seamless interaction with the mixed reality content. In some embodiments, the dynamically configurable user interface includes one or more modified elements or features visible in the mixed reality experience. The one or more modified elements or features include layout, controls, visual elements, and interaction paradigms based on contextual factors. The contextual factors may include user behavior, environmental inputs, device form factor, and available sensor data. The computing system 106 provides the Adaptive User Interface to offer intuitive and personalized interaction patterns within the mixed reality experience.

In one embodiment, the computing system 106 utilizes real-time sensor data for enabling at least real time 3D content adaptation, dynamic adjustment of the 3D content to create a highly interactive mixed reality experience. The computing system 106 enables a seamless and immersive mixed reality experience independent of an operating system. In addition, the computing system 106 provides consistent user experiences across different devices and platforms and eliminates a need for dedicated app installations. The computing system 106 utilizes an instant application mechanism for enabling contextual loading of one or more mixed reality modules.

In some embodiments, the computing system 106 utilizes a feedback loop to enhance the immersive experience. The user 102 engages with the mixed reality content. The computing system 106 continuously collects and analyzes data regarding user interactions, movements, and environmental conditions. The real-time feedback informs the computing system 106 of user preferences, behavioural patterns, and situational context. Accordingly, the computing system 106 optimizes the mixed reality content to adapt itself by altering the one or more visual elements, adjusting difficulty levels, or providing tailored narratives to enhance user engagement and satisfaction.

For instance, if a user demonstrates a preference for specific types of interactions or exhibits certain behaviours, the computing system 106 can adjust the mixed reality experience to prioritize those elements, thereby creating a more personalized and engaging environment. This adaptive process not only enhances the user experience but also fosters deeper immersion by ensuring that the mixed reality content remains relevant and responsive to individual user needs. The continuous feedback loop ensures that the mixed reality experience evolves in real time, maximizing engagement and retention.

In an implementation, the computing system 106 interacts with the server 114 and the database 116 to retrieve mixed reality experience metadata, user profiles, and relevant configuration parameters. The computing system 106 dynamically determines at least one mixed reality module of the plurality of mixed reality modules 110 suitable for deployment. Furthermore, the computing system 106 may generate or update a spatial map of physical environment of the user 104, orchestrate adaptive rendering instructions, and transmit an optimized mixed reality content to the communication device 104 in real time. The computing system 106 ensures efficient module delivery, manages runtime execution environments, and helps maintain cross-platform consistency across heterogeneous devices. In some embodiments, the computing system 106 based on real-time inputs received from the communication device 104. The real-time inputs include at least one of device specifications, environmental context, and user behavior.

In some embodiments, the processor 202, the memory 204, display unit of the communication device 104, and the modular mixed reality engine 108 cooperate at the hardware level to achieve enhanced computational efficiency and adaptive rendering performance. The processor 202 executes instructions retrieved from the non-transitory memory 204 to dynamically manage graphical workloads and to coordinate the real-time operation of the modular mixed reality engine 108. The modular mixed reality engine 108 orchestrates the execution of the one or more relevant mixed reality modules for the adaptive rendering based on system parameters. The interaction among the hardware components ensures optimized task scheduling, adaptive resource allocation, and efficient data exchange between processing and rendering subsystems. The hardware-level cooperation facilitates low-latency computation, stable frame rendering, and spatially coherent alignment of digital objects with real-world contexts. As a result, the computing system 106 achieves measurable technical improvements, such as reduced rendering latency, improved frame stability, and enhanced responsiveness, for delivering a high-performance, real-time mixed reality experience.

The execution of the computer-executable instructions by the one or more processors 202 causes a hardware-level adaptation of the rendering and computation parameters across the processor 202 and the memory 204, and the associated sensors of the communication device 104. The adaptation improves overall device operation by optimizing data throughput, reducing real-time rendering latency, and maintaining synchronization accuracy between virtual and physical content. In particular, the dynamic module loading mechanism significantly reduces memory footprint and processing overhead, to allow complex MR experiences to execute on devices with modest hardware specifications. The communication device 104 is able to deliver high-quality mixed reality rendering even with limited CPU and GPU capacity, demonstrating measurable improvements in frame stability, responsiveness, and power efficiency.

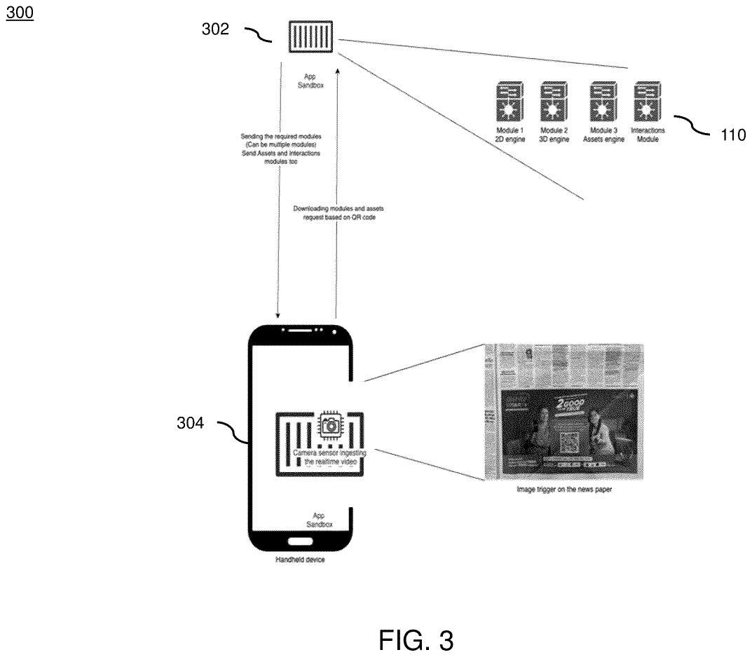

FIG. 3 illustrates an exemplary environment 300 for downloading of a sandbox at run time without downloading an instant application, in accordance with an embodiment of the present disclosure.

As shown, the environment 300 depicts a handheld device 304 executing within an application sandbox environment. The handheld device 304 may be a smartphone, a tablet, or a wearable computing device. The handheld device 304 includes a camera sensor operable to capture real-time video frames of a physical environment. In the depicted embodiment, a physical medium, such as a printed newspaper, includes an image trigger, for example, a Quick Response (QR) code, bar code, visual glyph, or any computer-vision-recognizable pattern.

Upon ingestion of the image trigger through the camera sensor, the application executing within the sandbox parses and identifies the trigger, thereby initiating a content request to a remote app sandbox server 302. The request includes a module and asset retrieval directive based on the specific image trigger identified.

The app sandbox server 302 orchestrates the retrieval and transmission of one or more modular engines and associated assets to the handheld device 304. As illustrated, the app sandbox server 302 may include a plurality of modular engines, including but not limited to module 1 (2D engine), module 2 (3D engine), module 3 (assets engine), and interactions module. The module 1 is operable to process and render two-dimensional content layers in the MR environment. The module 2 is operable to process and render three-dimensional spatial content. The module 3 is operable to retrieve, manage, and serve graphical assets, such as textures, meshes, audio files, and animation sequences. The interactions module is operable to cause and manage user interaction mechanisms, such as gesture-based input, touch input, gaze detection, or voice input, in coordination with rendered content.

Following transmission, the handheld device 304 dynamically loads and executes the received modules and assets within the device's sandboxed runtime environment.

The exemplary environment 300 allows for selective instantiation of only the components required for a given trigger context, thereby reducing computational overhead, memory usage, and network bandwidth consumption.

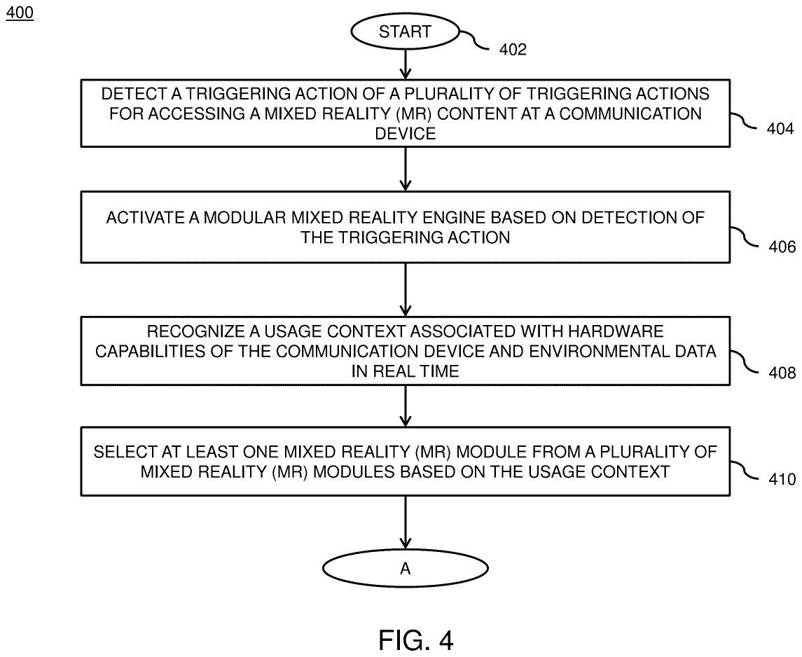

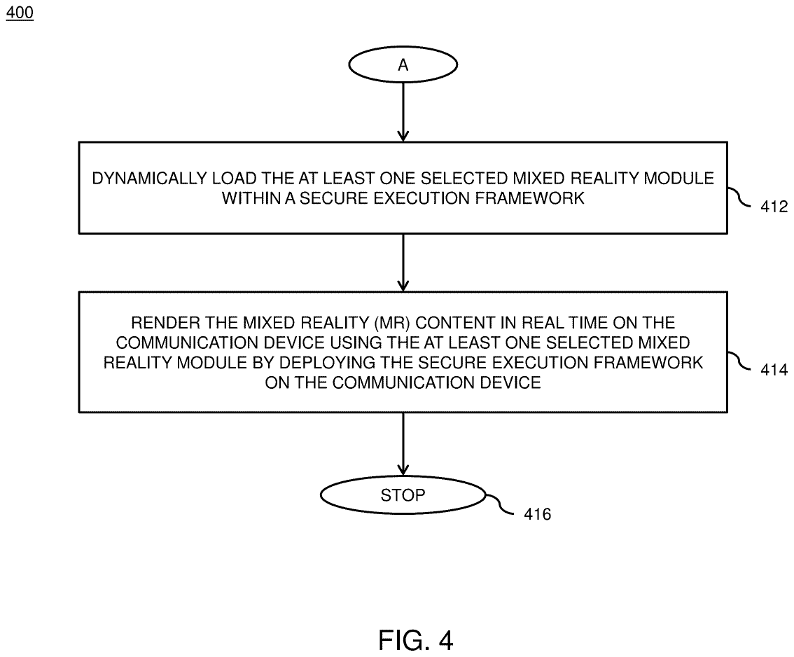

FIG. 4 illustrates a flow chart of a method 400 for rendering mixed reality (MR) content at the communication device 104, in accordance with various embodiments of the present disclosure. It may be noted that the description of the flowchart 400 refers to FIG. 1 and FIG. 2. The working and functioning may be read from the description of FIG. 1 and FIG. 2.

The flowchart 400 initiates at step 402. At step 404, the method includes detecting the triggering action of the plurality of triggering actions for accessing the mixed reality (MR) content at the communication device 104. The plurality of triggering actions includes but may not be limited to scanning the Quick Response (QR) code, clicking the hyperlink, detecting the near-field communication (NFC) tag, receiving the voice command, or recognizing the gesture input. In some embodiments, the Quick Response (QR) code may be captured through one or more cameras of the communication device 104, decoded, and utilized to extract the metadata required for initializing the modular mixed reality engine 108.

At step 406, the method includes activating the modular mixed reality engine 108 based on the detection of the triggering action of the plurality of triggering actions at the communication device 104. The modular mixed reality engine 108 includes the plurality of mixed reality (MR) modules 110. The modular mixed reality (MR) engine 108 enables the cross-module communication between the plurality of mixed reality (MR) modules 110. The cross-module communication facilitates the real-time synchronization of at least: 2D and 3D virtual content, the rendering states, and the user interactions across the plurality of mixed reality (MR) modules 110 based on the camera input, the gesture input, the touch input and the contextual data to deliver the immersive and adaptive mixed reality experience.

At step 408, the method includes recognizing the usage context based on the hardware capabilities of the communication device 104 and the environmental data in real time. The usage context recognition includes continuously assessing the device resource availability based on the set of parameters. The set of parameters includes at least the CPU utilization, the GPU utilization, the battery state, the network state and the thermal limits. Prior to recognizing the usage context, the method includes capturing the usage context through the camera module of the communication device 104.

At step 410, the method includes selecting the at least one mixed reality (MR) module from the plurality of mixed reality (MR) modules 110 based on the one or more pre-defined criteria and the usage context. The one or more pre-defined criteria used for selecting the at least one MR module are associated with the one or more features of the communication device 104. The one or more features include at least the type of the communication device 104, the hardware capabilities of the communication device 104, the operating system specifications of the communication device 104, the types of sensors in the communication device 104, and the rendering capacity of the communication device 104

At step 412, the method includes dynamically loading the at least one selected mixed reality module into the secure execution framework. The secure execution framework is deployed on the communication device 104. In an embodiment, the secure execution framework includes the instant application mechanism. The instant application mechanism includes temporarily deploying the instant application on the communication device 104. In an embodiment, the instant application has a pre-defined size ranging from 900 kilobytes to 1.2 megabytes. In some embodiments, the method includes dynamically loading the at least one selected mixed reality module with facilitation of the orchestrator module 214. The orchestrator module 214 dynamically loads the at least one selected mixed reality (MR) module in real-time based on the context inferred from the user input and the environmental data. The plurality of mixed reality modules 110 operate within the kernel-level application sandbox in the Linux-based system to ensure both performance and security. Prior to dynamically loading the at least one selected mixed reality (MR) module through the secure execution framework, the method includes determining whether the selected MR module is to be loaded on the communication device 104. The loading determination is based on evaluating the compatibility of the plurality of mixed reality (MR) modules 110 with the one or more features of the communication device 104 in real time.

At step 414, the method includes rendering the mixed reality (MR) content in real time on the communication device 104 using the selected at least one selected mixed reality module. The mixed reality content rendering includes rendering at least one digital object within the physical environment on the display of the communication device 104 based on the spatial map. The digital object is visually aligned with the real-time camera view captured by the camera module of the communication device 104. The method causes the seamless playback of the rendered mixed reality (MR) content on the communication device 104. The seamless playback is caused through the continuous optimization of resource utilization of the communication device 104. The flowchart 400 terminates at step 416.

The computing system 106 and the associated method perform the context-aware module selection, adaptive resource allocation, and sandboxed modular execution. Accordingly, the computing system 106 and the associated method optimize graphical and computational resource utilization during the mixed reality (MR) content rendering. The computing system 106 continuously analyzes the hardware parameters, the device performance metrics, and the environmental data to determine the most suitable mixed reality modules 110 for execution at any given moment. Based on the recognized usage context, the computing system 106 dynamically selects and loads only the relevant modules required for real-time rendering. Accordingly, the computing system 106 minimizes redundant computations and conserves system resources.

In an embodiment, the execution of the computer-executable instructions improves operation of the one or more processors by reducing computational cycles required for the real-time rendering of one or more virtual elements and performing the adaptive resource allocation. The one or more processors perform the adaptive resource allocation by adjusting rendering fidelity and computational priority based on real-time assessment of the hardware capabilities of the communication device. Accordingly, the reduction in the computation cycles and the adaptive resource allocation enhances system latency.

The adaptive resource allocation process involves real-time balancing of CPU, GPU, and memory workloads within the secure execution framework. The secure sandbox environment, instantiated through the modular mixed reality engine 108, isolates the module execution to prevent interference across processes. The isolation of the module execution process enhances the stability and the security. Further, the sandboxed modular execution architecture reduces system overhead by allocating computational tasks proportionally to available resources and based on hardware capabilities of the communication device 104. Through the mentioned coordinated operation, the computing system 106 achieves dynamic optimization of the graphical and the computational resource allocation. The dynamic optimization results in reduced rendering latency and improved frame stability. Moreover, the continuous synchronization between the loaded modules ensures that the one or more virtual elements are precisely aligned and spatially anchored with respect to the real-world view. The real-time synchronization maintains coherence between the physical environment and the rendered digital content. The synchronization provides seamless, low-latency mixed reality experience characterized by enabling enhanced responsiveness, spatial accuracy, and efficient performance across heterogeneous devices.

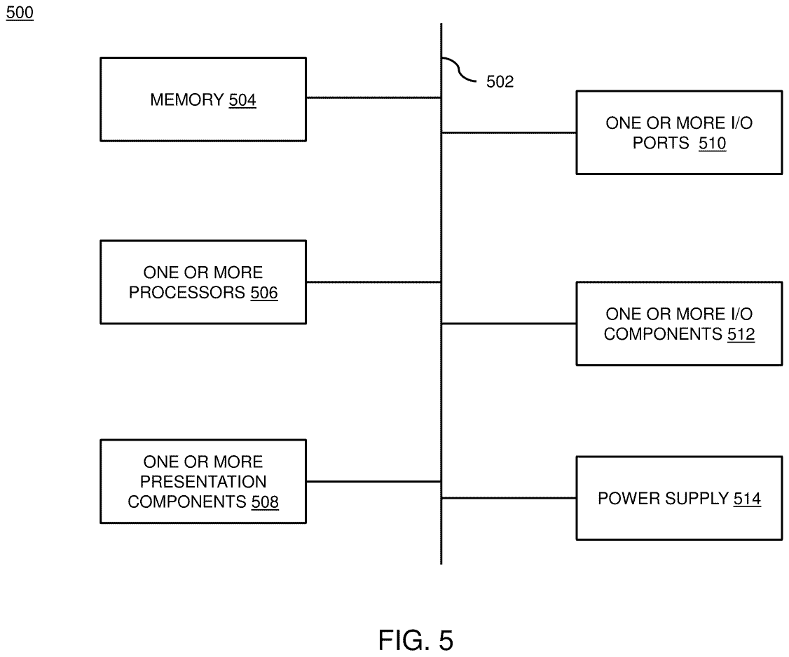

FIG. 5 illustrates a block diagram of an exemplary computing device 500 executing the rendering of the mixed reality (MR) content, in accordance with various embodiments of the present disclosure. The computing device 500 includes a bus 502 that directly or indirectly couples the following devices: memory 504, the one or more processors 506, one or more presentation components 508, one or more input/output (I/O) ports 510, one or more input/output components 512, and an illustrative power supply 514. The bus 502 represents what may be one or more buses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 5 is merely illustrative of the exemplary computing device 500 that can be used in connection with one or more embodiments of the present disclosure. Distinction is not made between such categories as “workstation,” “server,” “laptop,” “hand-held device,” etc., as all are contemplated within the scope of FIG. 5 and reference to “device.” The combination of context-aware module management, adaptive resource allocation, and sandboxed execution enhances the functioning of the computing device 500.

In some embodiments, the computing device 500 corresponds to a non-transitory computer-readable storage medium. The non-transitory computer-readable storage medium corresponds to a tangible hardware element operable to store the computer-executable instructions. The non-transitory computer-readable storage medium represents a tangible hardware element, such as a solid-state drive (SSD), flash memory, magnetic disk, optical disk, or read-only memory (ROM) that persistently stores data and program modules. The term non-transitory distinguishes the storage medium from transient signal forms, such as propagated signals or carrier waves, emphasizing the physical embodiment of the computer-implemented invention. In an embodiment of the present disclosure, the computing device 500 corresponds to a non-transitory computer-readable storage medium configured to store computer-executable instructions that, when executed by one or more processors 202, cause the computing device 500 to perform real-time rendering of mixed reality content. The non-transitory nature of the medium establishes a physical implementation of the invention, distinguishing it from transitory signal-based systems. The stored instructions are executed to perform adaptive hardware-level coordination between the processor 202, the memory 204, and the modular mixed reality engine 108. The cooperation enables the context-aware selection and the dynamic loading of the at least one mixed reality module in real time. The cooperation allows the computing system 106 to adjust the rendering fidelity and computational load according to the hardware capabilities of the communication device 104.

The execution of the stored instructions improves the operation of the computing device 400 by reducing redundant processing cycles and enabling intelligent resource scheduling across the CPU and GPU subsystems. The adaptive control of the rendering parameters ensures efficient use of available hardware resources, lowering thermal stress and minimizing latency in frame generation. The hardware-tied implementation results in measurable improvements in data throughput efficiency, frame synchronization, and spatial rendering accuracy. Accordingly, the non-transitory computer-readable medium facilitates deployment of lightweight, real-time mixed reality applications optimized as per the hardware capabilities of the communication device 104 to enable smooth and responsive performance even on devices with limited computational resources.

The computing device 500 typically includes a variety of computer-readable media. The computer-readable media can be any available media that can be accessed by the computing device 500 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 504 includes computer-storage media in the form of volatile and/or nonvolatile memory. The memory 504 may be removable, non-removable, or a combination thereof. Exemplary hardware devices include solid-state memory, hard drives, optical-disc drives, etc. The computing device 500 includes the one or more processors 506 that read data from various entities such as memory 504 or I/O components 512. The one or more presentation components 508 present data indications to a user or other device. Exemplary presentation components include a display device, speaker, printing component, vibrating component, etc. The one or more I/O ports 510 allow the computing device 500 to be logically coupled to other devices including the one or more I/O components 512, some of which may be built in. Illustrative components include a microphone, joystick, game pad, satellite dish, scanner, printer, wireless device, etc.

The present invention is described hereinafter by various embodiments. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby cause others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A computing system for dynamic mixed reality content rendering, the computing system comprising:
one or more processors; and
a non-transitory memory storing computer-executable instructions that, when executed, cause the one or more processors to:
detect a triggering action from a plurality of triggering actions for initiating access to the mixed reality (MR) content at a communication device;
activate a modular mixed reality engine in response to the detected triggering action, wherein the modular mixed reality engine comprises a plurality of mixed reality modules;
recognize a usage context associated with hardware capabilities of the communication device and environmental data in real time;
identify at least one mixed reality module from the plurality of mixed reality modules based on the recognized usage context;
dynamically load the at least one identified mixed reality module within a secure execution framework of the modular mixed reality engine; and
render the mixed reality (MR) content in real time on a display of the communication device using the at least one dynamically loaded mixed reality module,
wherein the one or more processors perform coordinated execution of the instructions to cause improvement in system performance through adaptive resource allocation, context-aware module management, and sandboxed execution that optimize resource utilization, reduce latency, enhance frame stability, and maintain spatial alignment, and wherein the one or more processors of the computing system are caused to perform the dynamic loading of the at least one mixed reality module to further cause lightweight, real-time mixed reality content rendering on devices with limited processing and memory resources.

2. The computing system of claim 1, wherein each of the plurality of triggering actions comprises an embedded metadata, wherein the metadata comprises device-specific parameters corresponding to the hardware capabilities of the communication device to cause adaptive loading of lightweight mixed reality modules, and wherein the metadata comprises at least one of a mixed reality (MR) experience identifier, asset locations, and one or more parameters controlling the mixed reality (MR) experience,

3. The computing system of claim 1, wherein the recognized usage context is determined by evaluating a plurality of parameters corresponding to the hardware capabilities of the communication device, wherein the plurality of parameters comprises least one of CPU utilization, GPU utilization, memory availability, network conditions, thermal thresholds or battery condition of the communication device to dynamically control module selection and resource allocation.

4. The computing system of claim 1, wherein the plurality of mixed reality (MR) modules comprises a flat image tracking module, a curved image tracking module, a ground tracking module, and an object tracking module, wherein each of the plurality of mixed reality modules is associated with one or more pre-defined functionalities configured for the dynamic loading, execution, and unloading each configured for dynamic loading and unloading according to the hardware capabilities of the communication device.

5. The computing system of claim 1, wherein the adaptive resource allocation comprises adjusting rendering fidelity and computational priority based on real-time assessment of the hardware capabilities of the communication device.

6. The computing system of claim 1, further comprising one or more machine learning models incorporated within the modular mixed reality engine, wherein the one or more machine learning models are operable to analyze real-time interaction and environmental data to optimize mixed reality module selection.

7. The computing system of claim 6, wherein execution of the one or more machine learning models within the modular mixed reality engine predicts user interaction patterns and pre-loads corresponding one or more mixed reality modules of the plurality of mixed reality modules to optimize computational efficiency based on the hardware capabilities of the communication device.

8. The computing system of claim 1, wherein the pre-loading of the one or more mixed reality modules based on the prediction of the user interaction patterns comprises:
collecting real-time interaction data, historical interaction data, and environmental context data;
training the one or more machine learning models using the historical data, wherein the one or more machine learning models are trained continuously with an updated training dataset;
analyzing the collected real-time interaction data using the trained one or more machine learning models to identify user behavior patterns;
predicting, by the one or more trained machine learning models, one or more user actions based on the analysis;
pre-loading the one or more mixed reality modules based on the predicted one or more user actions; and
continuously updating the predicted one or more user actions based on the real-time collected data.

9. A computer-implemented method executed by one or more processors of a computing system for dynamically rendering mixed reality (MR) content, the computer-implemented method comprising:
detecting, by a communication device, a triggering action from a plurality of triggering actions for initiating access to the mixed reality (MR) content;
activating a modular mixed reality engine in response to the detected triggering action, wherein the modular mixed reality engine comprises a plurality of mixed reality modules;
recognizing, in real time, a usage context associated with hardware capabilities of the communication device and environmental data;
identifying at least one mixed reality module from the plurality of mixed reality modules based on the recognized usage context in real time;
dynamically loading the at least one identified mixed reality module within a secure execution framework of the modular mixed reality engine; and
rendering the mixed reality (MR) content in real time on the communication device using the at least one identified mixed reality module by deploying the secure execution framework on the communication device,
wherein the one or more processors execute computer-executable instructions to improve functioning of the communication device through context-aware module selection, adaptive resource allocation, and sandboxed modular execution that optimize resource utilization, reduce latency, enhance frame stability, and maintain spatial alignment, and wherein the one or more processors execute the instructions to perform the dynamic loading of the at least one mixed reality module to further cause lightweight, real-time mixed reality content rendering on devices with limited processing and memory resources.

10. The computer-implemented method of claim 9, wherein the plurality of triggering actions is configured based on the hardware capabilities of the communication device, and wherein the plurality of triggering actions comprises at least scanning a Quick Response (QR) code through a camera module of the communication device, selecting a hyperlink received on the communication device, or detecting a near-field communication (NFC) tag through the communication device.

11. The computer-implemented method of claim 10, wherein the scanning of the QR code comprises:
capturing an image of the QR code using the camera module of the communication device;
decoding the captured image to extract encoded information; and
using the extracted information to initiate activation of the modular mixed reality engine.

12. The computer-implemented method of claim 10, wherein detection of the NFC tag through the communication device comprises:
establishing a near-field communication session;
retrieving data stored on the NFC tag; and
utilizing the retrieved data to activate the modular mixed reality engine.

13. The computer-implemented method of claim 9, wherein each of the plurality of triggering actions comprises an embedded metadata, wherein the metadata comprises device-specific parameters corresponding to the hardware capabilities of the communication device for adaptive loading of lightweight mixed reality modules, and wherein the metadata comprises at least one of a mixed reality (MR) experience identifier, asset locations, and one or more parameters controlling the mixed reality (MR) experience.

14. The computer-implemented method of claim 9, wherein the recognized usage context is determined by evaluating a plurality of parameters corresponding to the hardware capabilities of the communication device, wherein the plurality of parameters comprises least one of CPU utilization, GPU utilization, memory availability, network conditions, thermal thresholds or battery condition of the communication device to dynamically control module selection and resource allocation.

15. The computer-implemented method of claim 9, wherein the plurality of mixed reality (MR) modules comprises a flat image tracking module, a curved image tracking module, a ground tracking module, and an object tracking module, wherein each of the plurality of mixed reality modules is associated with one or more pre-defined functionalities configured for the dynamic loading, execution, and unloading each configured for dynamic loading and unloading according to the hardware capabilities of the communication device.

16. The computer-implemented method of claim 9, wherein the one or more processors are caused to execute the computer-executable instructions that improves operation of the one or more processors by reducing computational cycles required for the real-time rendering of one or more virtual elements and performing the adaptive resource allocation by adjusting rendering fidelity and computational priority based on real-time assessment of the hardware capabilities of the communication device for enhancing system latency.

17. The computer-implemented method of claim 9, further comprising incorporating one or more machine learning models within the modular mixed reality engine, wherein the one or more machine learning models are operable to analyze real-time interaction and environmental data.

18. The computer-implemented method of claim 9, wherein execution of the one or more machine learning models within the modular mixed reality engine predicts user interaction patterns and pre-loads corresponding one or more mixed reality modules of the plurality of mixed reality modules to optimize computational efficiency based on the hardware capabilities of the communication device.

19. The computer-implemented method of claim 9, wherein the pre-loading of the one or more mixed reality modules based on the prediction of the user interaction patterns comprises:
collecting real-time interaction data, historical interaction data, and environmental context data;
training the one or more machine learning models using the historical data, wherein the one or more machine learning models are trained continuously with an updated training dataset;
analyzing the collected real-time interaction data using the trained one or more machine learning models to identify user behavior patterns;
predicting, by the one or more trained machine learning models, one or more user actions based on the analysis;
pre-loading the one or more mixed reality modules based on the predicted one or more user actions; and
continuously updating the predicted one or more user actions based on the real-time collected data.

20. A non-transitory computer-readable storage medium storing computer-executable instructions which, when executed by one or more processors of a computing device, cause the computing device to perform a method for dynamic and adaptive mixed reality content display, the method comprising:
detecting, by a communication device, a triggering action from a plurality of triggering actions for initiating access to the mixed reality (MR) content;
activating a modular mixed reality engine in response to the detected triggering action, wherein the modular mixed reality engine comprises a plurality of mixed reality modules;
recognizing a usage context associated with hardware capabilities of the communication device and environmental data in real time;
identifying at least one mixed reality module from the plurality of mixed reality modules based on the recognized usage context in real time;
dynamically loading the at least one identified mixed reality module within a secure execution framework of the modular mixed reality engine; and
rendering the mixed reality (MR) content in real time on the communication device using the at least one dynamically loaded mixed reality module by deploying the secure execution framework on the communication device,
wherein execution of the stored instructions by the one or more processors improves operation of the computing device through context-aware module selection, adaptive resource allocation, and sandboxed modular execution that optimize computational efficiency and frame stability, and wherein the one or more processors of the computing device are caused to perform the dynamic loading of the at least one mixed reality module to deploy lightweight, low-resource instant applications suited to the hardware capabilities of the communication device for efficient mixed reality content rendering on devices with limited computational capacity.
